(19) United States
(12) Patent Application Publication
(10) Pub. No.: US 2020/0363671 A1
(43) Pub. Date: Nov. 19, 2020

(54) Display Panel With Integrated Force-Touch Sensor And Display Device Including Same

(71) Applicant: ILJIN DISPLAY CO., LTD., Chungcheongbuk-do (KR)

(72) Inventors: Kyun AHN, Chungcheongbuk-do (KR); Yunhee CHUNG, Chungcheongbuk-do (KR); Jun Sik KANG, Chungcheongbuk-do (KR); Han Ju YU, Chungcheongbuk-do (KR); Yong Hee SHIN, Chungcheongbuk-do (KR)

(73) Assignee: ILJIN DISPLAY CO., LTD.

(21) Appl. No.: 16/839,356

(22) Filed: Apr. 3, 2020

(30) Foreign Application Priority Data
May 14, 2019 (KR) 10-2019-0056008

(51) Int. Cl. G02F 1/1333; G02F 1/13357; G02F 1/1335; G02F 1/1339

(52) U.S. Cl. CPC G02F 1/13338; G02F 1/133602; G02F 2202/28; G02F 1/133514; G02F 1/13394; G02F 1/133512

(57) ABSTRACT

Provided is a display panel that includes: a display module that includes a liquid crystal layer, a backlight module having a light source, a light guide plate that guides light emitted from the light source to the display module, and a bottom chassis that houses the light source and the light guide plate; and a force-touch module located between the display module and the bottom chassis. The present disclosure makes force-touch sensing possible even under the presence of an air gap inside the display panel.

### CROSS-REFERENCE TO RELATED APPLICATIONS

This application claims priority to Korean Patent Application No. 10-2019-0056008 filed on May 14, 2019 in the Korean Intellectual Property Office, the entire content of which is hereby incorporated by reference in its entirety.

### FIELD

The present disclosure relates generally to a display panel and a display device including the same and, more particularly, to a display panel with an integrated force-touch sensor and a display device including the same.

### BACKGROUND

A recent touch input technology which has been attracting attention is a technology that enables a user to select or input a desired function, and has been applied to various electronic and communication devices such as a smart phone, a smart TV, a laptop, a personal digital assistant (PDA), a game console, and a navigation.

As an application executing various functions in the smart phone, the smart TV, and other various terminals appears at present, a technology that is made to perform an operation based on various characteristics of a touch, for example, a touch pressure in addition to a simple touch position is required in a touch panel.

Thus, studies on a touch input device capable of detecting a touch position as well as a force magnitude (i.e., a pressure magnitude) of the touch on a touch screen without reducing performance of a display module, and more particularly a force-touch sensor are actively made.

FIG. 1 illustrates a general structure of a display device, and FIGS. 2A and 2B illustrate a structure of a conventional display panel.

As illustrated in FIG. 1, a conventional display device (e.g., a smart phone) has a structure in which a force-touch panel is attached under a display panel and a frame is located in a direction under the force-touch panel.

Referring to FIGS. 2A and 2B, the conventional display panel includes a display module 1 having a configuration in which an array substrate as a lower substrate and a color filter substrate as an upper substrate face each other, a backlight module 2 that emits light toward the display module 1, and a top chassis 3 and a bottom chassis 4 that surround the display module 1 and the backlight module 2.

Depending on positions of light sources 6, the backlight module 2 inside the display panel can be generally classified into an edge type structure, as in FIG. 2A, in which the light sources 6 are disposed on a rear lateral side of the display module 1, and a direct type structure, as in FIG. 2B, in which the light sources 6 are disposed directly on a rear side of the display module 1. Both the structures have a structure in which the display module 1 and an air gap 5 are formed in the display panel.

Meanwhile, a process of sensing a pressure includes a process of sensing a variation in resistance through contact of electrodes formed on the force-touch panel. In the case of a liquid crystal display (LCD), there is a problem that a load is not easily transmitted to the force-touch panel due to the air gap 5 formed inside the LCD and the bottom chassis 4 formed outside the LCD even if the force-touch panel is attached under the bottom chassis 4 of the LCD and a lower portion of the force-touch panel is supported by the frame.

### SUMMARY

An aspect of the present disclosure is to solve the aforementioned problem and other problems. Another aspect of the present disclosure is to provide a display device that makes reliable force-touch sensing possible even in the presence of an air gap in a display panel.

In view of the foregoing, a display panel according to an aspect of the present disclosure includes: a display module having a liquid crystal layer; a backlight module having a light source, a light guide plate that guides light emitted from the light source to the display module, and a bottom chassis that houses the light source and the light guide plate; and a force-touch module located between the display module and the bottom chassis.

A display device according to another aspect of the present disclosure includes: a cover glass configured to protect a front surface of the display device; a touch panel configured to have a touch sensor that detects a touch of a user; a display panel configured to include a display module having a liquid crystal layer, a backlight module having a light source, a light guide plate that guides light emitted from the light source to the display module, and a bottom chassis that houses the light source and the light guide plate, and a force-touch module located between the display module and the bottom chassis; and a frame located below the display panel.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1 illustrates a general structure of a display device.

FIGS. 2A and 2B schematically illustrate a conventional display panel.

FIG. 3 schematically illustrates a layered structure of a display device 10000 according to an embodiment of the present disclosure.

FIG. 4 schematically illustrates a display panel 1000 according to an embodiment of the present disclosure.

FIG. 5 is a sectional view of the display panel 1000 taken along line A-A′ of FIG. 4 according to the embodiment of the present disclosure.

FIG. 6 schematically illustrates a force-touch module 200 according to an embodiment of the present disclosure.

FIG. 7 is a sectional view of the force-touch module 200 according to the embodiment of the present disclosure.

FIG. 8 is a sectional view of a force-touch module 200 according to another embodiment of the present disclosure.

FIG. 9 is a top view of a bottom chassis 400 according to an embodiment of the present disclosure.

FIG. 10 is a sectional view of the bottom chassis 400 taken along line B-B′ of FIG. 9 according to the embodiment of the present disclosure.

FIGS. 11A and 11B schematically illustrate an arrangement form of the force-touch module 200 according to the embodiment of the present disclosure.

FIGS. 12A and 12B illustrate an actual photograph of the display panel 1000 according to the embodiment of the present disclosure; and

FIGS. 13A and 13B illustrate a measurement result of an ADC level of the display device 10000 according to the embodiment of the present disclosure.

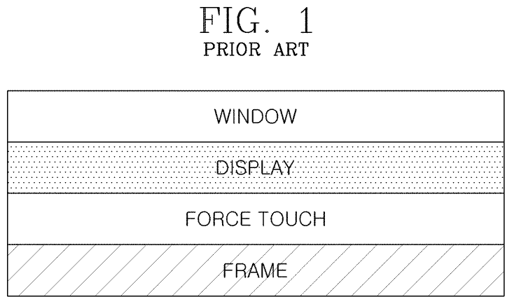

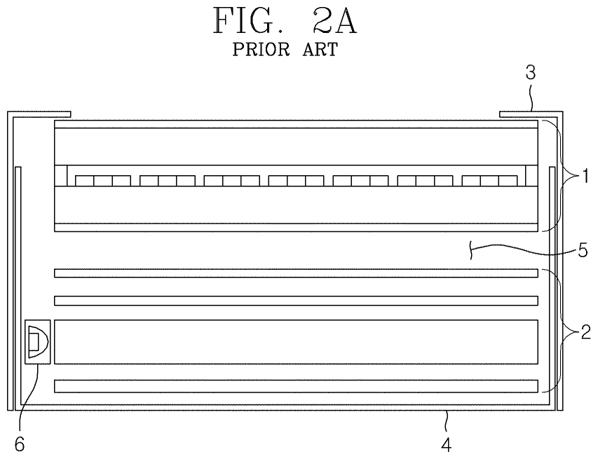

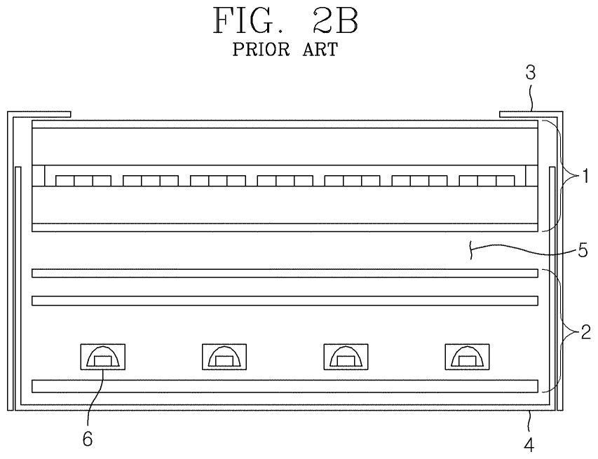

### DETAILED DESCRIPTION

Hereinafter, embodiments disclosed herein will be described in detail with reference to the attached drawings. Identical or similar components are denoted with the same reference numerals regardless of the drawing number, and a duplicate description thereof will be omitted. In the following description of the embodiments according to the present disclosure, in the case where a layer (film), region, pattern or structure is referred to as being “on” or “under” another substrate, layer (film), region, pad, or pattern, this denotes that the layer (film), region, pattern or structure is formed directly on/under the other substrate, layer (film), region, pad, or pattern, or is formed indirectly on/under the other substrate, layer (film), region, pad, or pattern via one or more intervening layers. Further, the description relative to on or under of each layer will be given based on the drawings. In the drawings, the thickness or size of each layer is exaggerated, omitted, or schematically illustrated for convenience of description and clarity. Also, the size of each component does not entirely reflect the actual size thereof.

Further, in the description of the embodiments disclosed herein, a detailed description of the related well-known technology will be omitted when it may make the subject matters of the embodiments disclosed herein unclear. Further, it should be understood that the attached drawings are provided only to help easy understanding of the embodiments disclosed herein, and the technical idea disclosed herein is not limited by the attached drawings and covers all modifications, equivalents, and alternatives falling within the idea and technical scope of the present disclosure.

The present disclosure proposes a display device that makes reliable force-touch sensing possible even in the presence of an air gap in a display panel.

Hereinafter, various embodiments of the present disclosure will be described in detail with reference to the drawings.

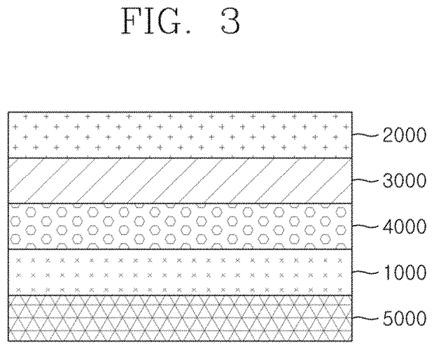

FIG. 3 schematically illustrates a layered structure of a display device 10000 according to an embodiment of the present disclosure.

The display device 10000 according to the present disclosure includes a cover glass 2000 that protects a front surface of the display device 10000, a touch panel 4000 that has a touch sensor for detecting a touch of a user, an optical clear adhesive (OCA) 3000 that is provided between the cover glass 2000 and the touch panel 4000 and adheres the cover glass 2000 and the touch panel 4000, a display panel 1000 that is located under the touch panel 4000, and a frame 5000 that is located under the display panel 1000 and supports the display panel 1000.

The display device 10000 according to the present disclosure refers to all video devices that implement visual information on a screen, and includes a navigation unit, a television, a monitor, a laptop, a tablet PC, a smart phone, a center information display (CID) of a vehicle, and other various portable terminals. The display panel 1000 refers to a device that is a display part of the display device 10000 and expresses optical properties according to a change in voltage or temperature.

The display panel 1000 according to the present disclosure includes a display module 100 that displays an image, a force-touch module 200, a backlight module 300 that emits light toward the display module 100, a bottom chassis 400 that houses the backlight module 300, a first coupling member 500 that connects the force-touch module 200 and the bottom chassis 400, and a second coupling member 600 that connects the force-touch module 200 and the display module 100. A detailed description of the display panel 1000 will be described below.

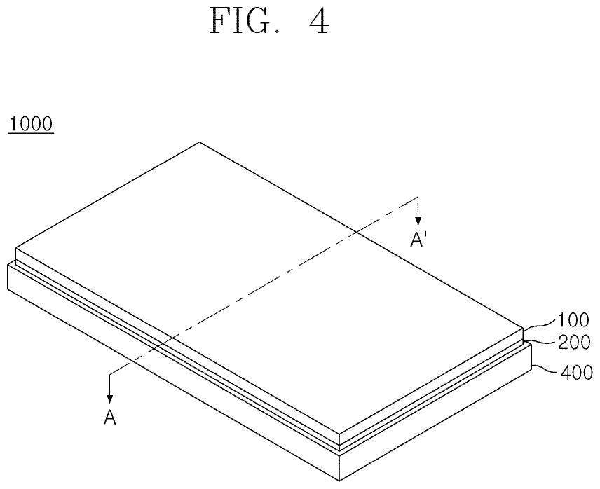

FIG. 4 schematically illustrates a display panel 1000 according to an embodiment of the present disclosure.

The display device may be classified into a light emitting type such as an organic light emitting diode (OLED) that uses a display panel that spontaneously emits light, and a light receiving type such as a liquid crystal display (LCD) that uses a display panel that does not spontaneously emit light and should be supplied with light from a backlight module. The display panel 1000 according to the present disclosure may be the LCD supplied with light from the backlight module 300.

To be specific, the display panel 1000 according to the present disclosure includes the display module 100, the force-touch module 200, the backlight module 300, and the bottom chassis 400 that houses the backlight module 300. The force-touch module 200 is located between the display module 100 and the bottom chassis 400 in the display panel 1000 to be able to effectively sense a force-touch event of the user.

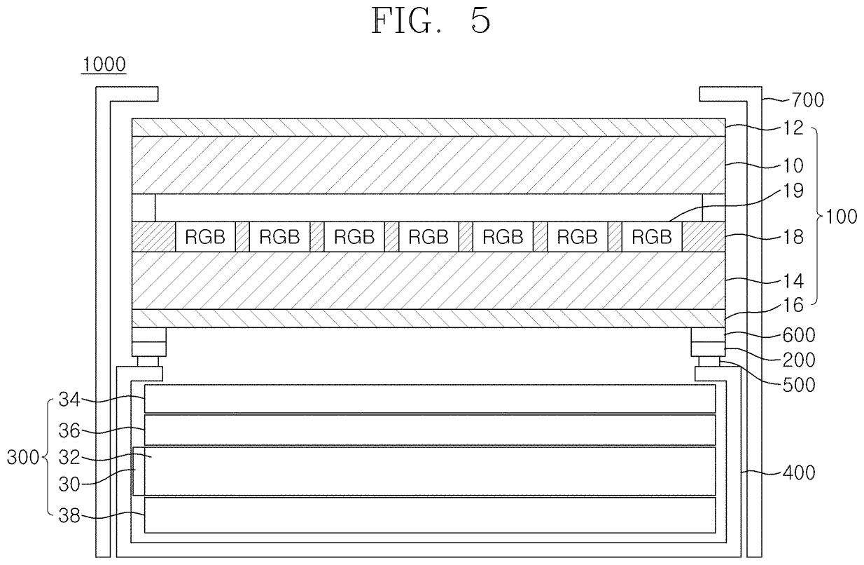

The force-touch module 200 may be formed continuously or intermittently along an upper end edge of the bottom chassis 400, and the first coupling member 500 connecting the force-touch module 200 and the bottom chassis 400 and the second coupling member 600 connecting the force-touch module 200 and the display module 100 may also be formed at positions corresponding to the bottom chassis 400, the display module 100, and the force-touch module 200 such that the bottom chassis 400, the display module 100, and the force-touch module 200 are easily adhered. Hereinafter, an interlayered structure of the aforementioned display panel 1000 will be described in detail with reference to FIG. 5.

FIG. 5 is a sectional view of the display panel 1000 taken along line A-A′ of FIG. 4 according to the embodiment of the present disclosure.

The display panel 1000 according to the present disclosure includes the display module 100 having a liquid crystal layer (not illustrated), the backlight module 300 that includes a light source 30, a light guide plate 32 that guides light emitted from the light source 30 to the display module 100, and the bottom chassis 400 that houses the light source 30 and the light guide plate 32, and the force-touch module 200 that is located between the display module 100 and the bottom chassis 400. The display module 100 may further include a first substrate 10 that is an upper substrate, a second substrate 14 that is a lower substrate, and a color filter 19 and an edge black matrix region 18 that are disposed between the first substrate 10 and the liquid crystal layer (not illustrated).

The display module 100 may be a liquid crystal display module in which the liquid crystal layer (not illustrated) is disposed between the two substrates 10 and 14 on which switching elements, electrodes, color filters, etc. are disposed. The first substrate 10 that is the upper substrate and the second substrate 14 that is the lower substrate are located to face each other, and a first polarization layer 12 and a second polarization layer 16 may be located on an upper surface of the first substrate 10 and a lower surface of the second substrate 14 respectively. The display module 100 adjusts transmittance of the light, which is provided by the backlight module 300 and passes the second polarization layer 16, the liquid crystal layer (not illustrated), and the first polarization layer 12, under the control of a driving device in units of a pixel and displays an image. To be specific, the light is polarized by the second polarization layer 16, and the polarized light is incident upon the liquid crystal layer (not illustrated). The light that is incident upon the liquid crystal layer (not illustrated) may maintain a polarizing direction or may be rotated at a right angle according to arrangement of the liquid crystal layer (not illustrated), and may be incident upon the first polarization layer 12. Afterward, the light maintaining the polarizing direction is shielded by the first polarization layer 12, and the light rotated at the right angle passes the first polarization layer 12, and thereby an image may be implemented.

The color filter 19 and the edge black matrix region 18 may be provided between the first substrate 10 and the liquid crystal layer (not illustrated). Each pixel black matrix may be provided between pixels of the color filter 19, and the edge black matrix region 18 may be provided at an edge of the color filter 19. Meanwhile, the display module 100 may further include one or more spacers that separate the first substrate 10 and the second substrate 14 at a prescribed distance.

The backlight module 300 is disposed in the rear of the display module 100, and guides the light emitted from the light source 30 toward the display module 100 via the light guide plate 32. As described above, the backlight module 300 may be classified into the direct type and the edge type according to the positions of the light sources. The present disclosure gives an edge type backlight module by way of example, but it is not limited thereto. The present disclosure may be applied to a direct type backlight module.

The backlight module 300 may include the light source 30 that is supplied with power, converts electric energy into light energy, and discharges the light energy, the light guide plate 32 that guides the light emitted from the light source 30 toward the display module 100, a diffuser sheet 36 that scatters the light guided by the light guide plate 32 and uniformly diffuses brightness distribution, a prism sheet 34 that makes a travelling direction of the light diffused by the diffuser sheet 36 perpendicular to the display module 100, and a reflector sheet 38 that reflects and scatters the light travelling downward from the light guide plate 32, finally directs the light toward the display module 100, and thereby prevents optical loss.

An upper portion of the bottom chassis 400 is open, a storage space having a prescribed depth is formed, and the bottom chassis 400 can house the backlight module 300. The bottom chassis 400 may be formed of a material having high rigidity so as to be able to protect the backlight module 300 from an external shock. A detailed description of the bottom chassis 400 will be described below. Meanwhile, the display panel 1000 according to the present disclosure may further include a top chassis 700 that encloses at least a part of the display module 100 to protect the display module 100 and prevents the display module 100 from being separated from the backlight module 300.

The force-touch module 200 is located between the display module 100 and the bottom chassis 400 in the display panel 1000 to be able to effectively sense a force-touch action of a user. The force-touch module may detect a variation in resistance caused by contact of the electrodes and sense sensitivity based on a load. The force-touch module 200 is disposed at a position corresponding to the edge black matrix region 18 provided between the first substrate 10 and the liquid crystal layer (not illustrated) of the display module 100, and may have a width that is smaller than or equal to the edge black matrix region 18. A detailed description of the force-touch module 200 will be described below.

The first coupling member 500 connects the force-touch module 200 and the bottom chassis 400, and the second coupling member 600 connects the force-touch module 200 and the display module 100. Either the first coupling member 500 or the second coupling member 600 basically performs an adhesion function, and may be a double-sided tape, a thermosetting adhesive, a photocurable adhesive, or a foam tape.

Either the first coupling member 500 or the second coupling member 600 may function to relieve or prevent a shock applied to the force-touch module 200 in addition to functioning to adhere the force-touch module 200 and the bottom chassis 400 and functioning to adhere the force-touch module 200 and the display module 100. Further, a width of the first coupling member 500 is provided below a width of the force-touch module, which causes an applied force to be fully concentrated on the force-touch module 200 so that force-touch performance can be improved. A thickness of the first coupling member 500 may range from 0.5 mm to 3.0 mm.

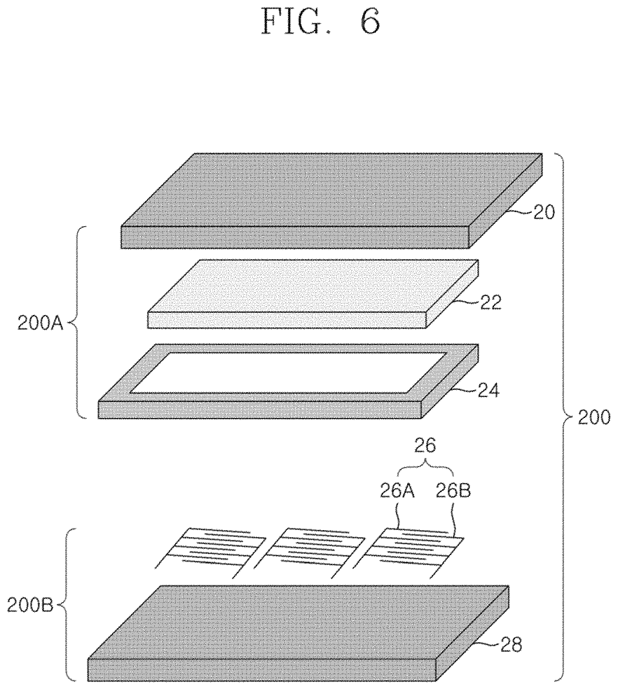

FIG. 6 schematically illustrates the force-touch module 200 according to an embodiment of the present disclosure.

The force-touch module 200 according to the present disclosure is made up of a top layer 200A and a bottom layer 200B. The top layer 200A includes a third substrate 20, an elastic resistor member 22, and a spacer 24 that separates the third substrate 20 and a fourth substrate 28, and the bottom layer 200B includes an electrode structure 26 and the fourth substrate 28. Each electrode structure 26 of the bottom layer 200B may have a form in which a power supply (VCC or Tx) electrode 26A and a ground (GND or Rx) electrode 26B are disposed apart from each other.

The third substrate 20 of the top layer 200A may be formed of a transparent or opaque plastic material. The transparent or opaque plastic material may be polyethylene terephthalate (PET), polycarbonate (PC), polyether sulfone (PES), polynorbornene (PNB), polypropylene (PP), or polyimide (PI). The fourth substrate 28 of the bottom layer 200B is formed of the same material as the third substrate 20, and is located to face a lower surface of the third substrate 20.

The elastic resistor member 22 is provided on the lower surface of the third substrate 20. The elastic resistor member 22 may be formed of a variable resistance material having adhesion along with a characteristic that, as a contact area with the electrode increases, a resistance value decreases. For example, the variable resistance material may be a pressure sensitive adhesive material based on any one of a quantum tunneling composite (QTC), an electro-active polymer (EAP), an acrylic solvent, and a rubber-based solvent, or a piezoresistive material. The piezoresistive material has a piezoresistive effect in that a specific resistance varies as conduction energy occurs when an external force is applied to a silicon semiconductor crystal and electric charges move to a conduction band.

Meanwhile, the electrode structure 26 is provided on an upper surface of the fourth substrate 28. The number of electrode structures 26 may be two or more, and the electrode structures 26 may be formed of a metal material. The metal material may be, for example, silver (Ag).

The spacer 24 is configured to separate the third substrate 20 and the fourth substrate 28, and may include an adhesive layer that adheres the third substrate 20 and the fourth substrate 28. The adhesive layer may be, for example, a gasket.

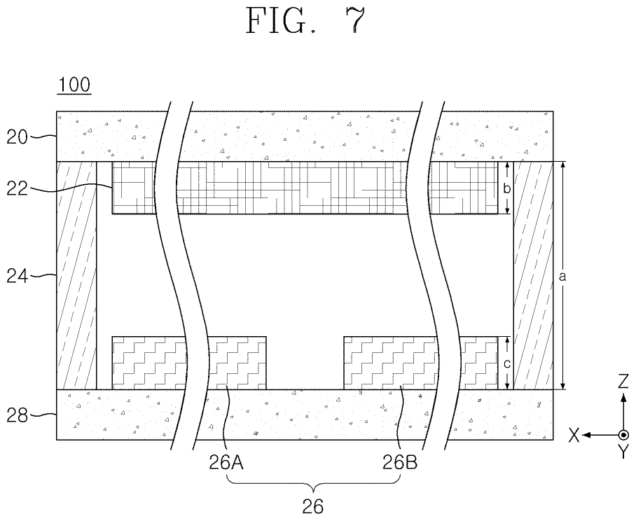

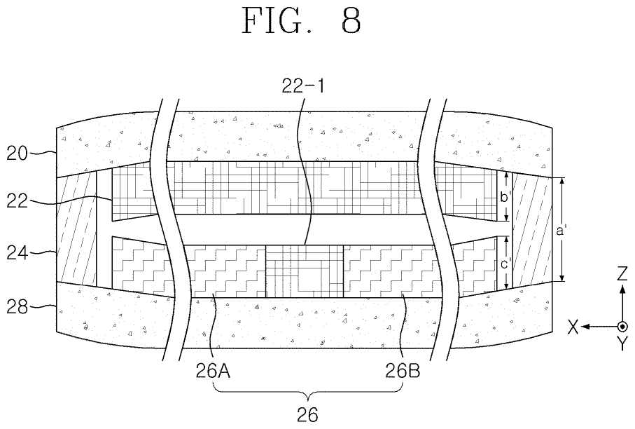

FIG. 7 is a sectional view of the force-touch module 200 according to the embodiment of the present disclosure, and FIG. 8 is a sectional view of a force-touch module 200 according to another embodiment of the present disclosure.

FIG. 7 illustrates a structure in which the spacer 24 having a greater thickness than a value obtained by adding a thickness of the elastic resistor member 22 and a thickness of the electrode structure 26 is applied (i.e., a>b+c), and FIG. 8 illustrates a structure in which the spacer 24 having a smaller thickness than the value obtained by adding the thickness of the elastic resistor member 22 and the thickness of the electrode structure 26 is applied (i.e., a′<b′+c′).

All the structures illustrated in FIGS. 7 and 8 may be applied to the display panel 1000 of the present disclosure. However, the structure illustrated in FIG. 8 is a structure in which an air gap between the elastic resistor member 22 and the electrode structure 26 is minimized, and can further improve durability and reliability.

The force-touch module 200 illustrated in FIG. 8 may be implemented by applying the spacer 24 having the smaller thickness than the value obtained by adding the thickness of the elastic resistor member 22 and the thickness of the electrode structure 26 and forcibly bringing the elastic resistor member 22 into physical contact with the electrode structure 26. The electrode structure 26 includes the power supply (VCC or Tx) electrode 26A and the ground (GND or Rx) electrode 26B.

As an embodiment, the thickness b′ of the elastic resistor member 22 may range from 6 μm to 10 μm, the thickness c′ of the electrode structure 26 may range from 4 μm to 5 μm, and the thickness a′ of the spacer 24 may range from 5 μm to 10 μm.

More preferably, the thickness b′ of the elastic resistor member 22 may be set to 8 μm, the thickness c′ of the electrode structure 26 may be set to 4 μm, and the thickness a′ of the spacer 24 may be set to 10 μm or less. The thickness of the spacer 24 is set to 10 μm or less, and thereby a minimum gap between the third substrate 20 and the fourth substrate 28 can be implemented.

Actually, as a result of applying the spacer 24 having a smaller thickness (5 μm) than a value obtained by adding a thickness (about 8 μm) of the elastic resistor member 22 and a thickness (about 4 μm) of the electrode structure 26, forcibly bringing the elastic resistor member 22 into physical contact with the electrode structure 26, and analyzing a cross section, it was confirmed that a gap between the third substrate 20 and the fourth substrate 28 was about 10 μm. As the thickness a′ of the spacer 24 becomes small, contact between the elastic resistor member 22 and the electrode structure 26 may become firmer. However, the thickness a′ of the spacer 24 should be set in consideration of physical properties of a material.

The force-touch module 200 according to the present disclosure detects a pressure, weight, a touch, etc. using a principle that a resistance value is reduced when a pressure is applied. That is, if the force-touch event of the user is applied above a reference pressure, the elastic resistor member 22 comes into contact with the electrode structure 26 disposed on the fourth substrate 28. At a point in time when the elastic resistor member 22 comes into contact with the electrode structure 26, the electrode structure 26 is put in a conduction state due to the elastic resistor member 22, an electric current flows to the power supply (VCC or Tx) electrode 26A and the ground (GND or Rx) electrode 26B of the electrode structure 26 through the elastic resistor member 22, and the force-touch event occurs.

That is, the force-touch event occurs due to the contact between the electrodes. The elastic resistor member 22 above the power supply (VCC or Tx) electrode 26A and the ground (GND or Rx) electrode 26B comes into contact with both the electrodes so as to cover both the electrodes, and electrically connects both the electrodes. Thus, the force-touch event occurs as resistance is formed between both the electrodes. A phenomenon in that the resistance is reduced when the pressure is applied is caused by a change in a contact area between the elastic resistor member 22 and the electrode structure 26, and a quantum tunneling effect that is generated inside the elastic resistor member 22.

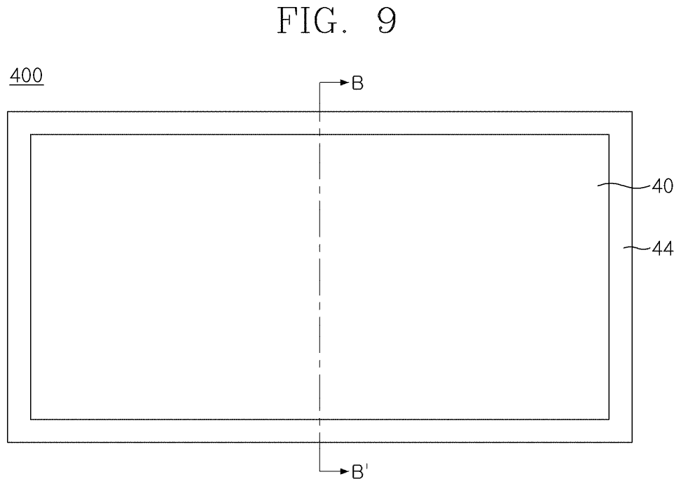

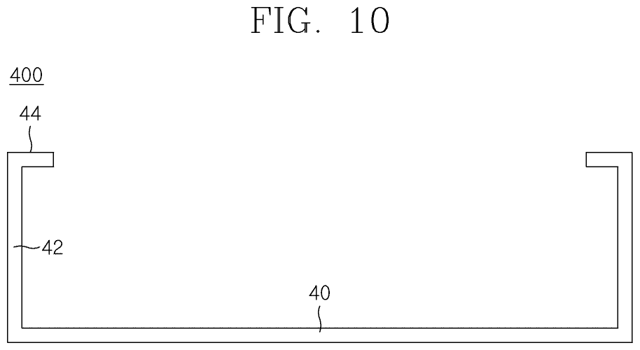

FIG. 9 is a top view of a bottom chassis 400 according to an embodiment of the present disclosure, and FIG. 10 is a sectional view of the bottom chassis 400 taken along line B-B′ of FIG. 9 according to the embodiment of the present disclosure.

The bottom chassis 400 according to the present disclosure includes a bottom 40, a sidewall 42 that is bent to extend from the bottom 40, and a bent top 44 that extends and is again bent from the bent sidewall 42. For example, a shape of the bottom 40 is a quadrilateral shape having four sides. The sidewall 42 may be bent to extend from an end of the bottom 40, may be nearly perpendicular to the bottom 40, and be formed to surround the end of the bottom 40. If the bottom 40 of the bottom chassis 400 is formed in a quadrilateral shape, the bent top 44 may be bent to extend from the sidewall 42 extending from the bottom 40. That is, the bent top 44 may extend from the sidewall. The bent top 44 of the bottom chassis 400 may be formed to face the display module 1000.

Referring to FIGS. 5 and 10 together, the force-touch module 200 may be formed between the display module 100 and the bottom chassis 400, and more particularly between the second polarization layer 16 of the display module 100 and the bent top 44 of the bottom chassis 400.

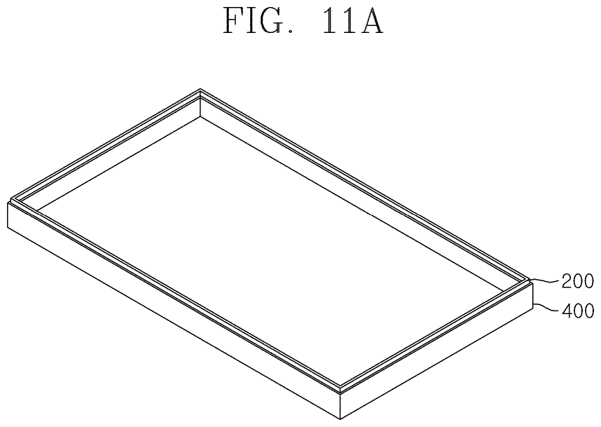

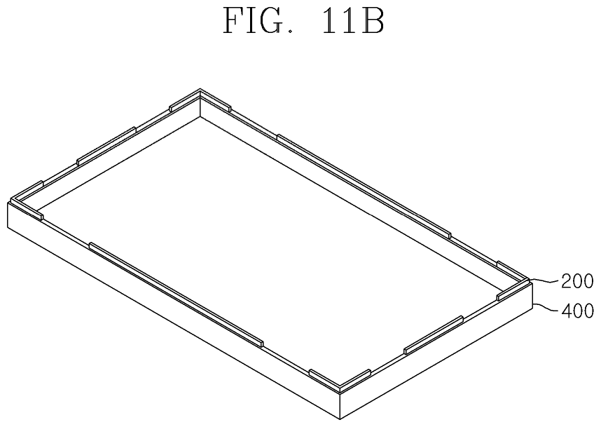

The force-touch module 200 may be continuously or intermittently formed along the bent top 44 of the bottom chassis 400 to surround an upper end of the bottom chassis 400. FIG. 11A illustrates a shape in which the force-touch module 200 is continuously disposed along the bent top 44 of the bottom chassis 400, and FIG. 11B illustrates a shape in which the force-touch module 200 is intermittently disposed along the bent top 44 of the bottom chassis 400. The disposition of the force-touch module 200 formed on the bottom chassis 400 is not limited to the shapes illustrated in FIGS. 11A and 11B, and may be disposed in various shapes as needed. In this case, the force-touch module 200 may be disposed under the edge black matrix region provided on the second substrate 14 of the display module 100.

The force-touch module 200 may be formed to have a width that is smaller than or equal to the width of the edge black matrix region provided on the second substrate 14. The width of the edge black matrix may be provided to have substantially the same width throughout four sides (edges) of the screen, and be provided to have different widths at least at the two sides of the four sides of the screen.

Meanwhile, the force-touch module 200 and the bottom chassis 400 are connected via the first coupling member 500. One surface of the first coupling member 500 may be in contact with the fourth substrate 28 of the force-touch module 200, and the other surface of the first coupling member 500 may be in contact with the bent top 44 of the bottom chassis 400. For example, a width of the first coupling member 500 may be smaller than or equal to that of the force-touch module 200, and a thickness of the first coupling member 500 may range from 0.5 mm to 3.0 mm.

Further, the force-touch module 200 and the display module 100 are connected via the second coupling member 600. One surface of the second coupling member 600 is in contact with the third substrate 20 of the force-touch module 200, and the other surface of the second coupling member 600 may be in contact with the second polarization layer 16 of the display module 100.

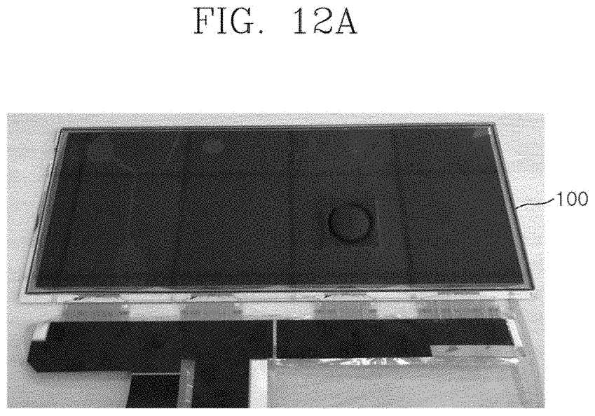

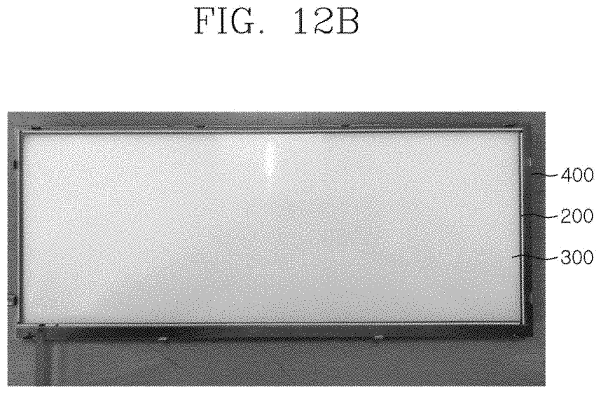

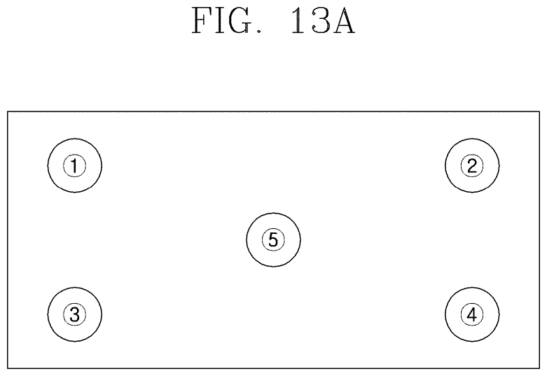

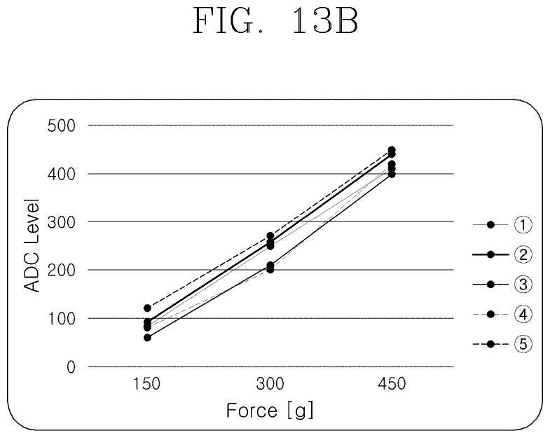

FIGS. 12A and 12B illustrate an actual photograph of the display panel 1000 according to the embodiment of the present disclosure, and FIGS. 13A and 13B illustrate results of measurement of an ADC level of the display panel 1000 according to the present disclosure.

To be specific, FIG. 12A illustrates the display module 100, FIG. 12B illustrates the force-touch module 200, the backlight module 300, and the bottom chassis 400, and FIGS. 13A and 13B illustrate points and values of the measurement of the ADC level of the display device 10000 in which the display panel 1000 of FIGS. 12A and 12B is included.

FIG. 13A illustrate the points of the measurement of the ADC level. Here, an analog to digital converter (ADC) converts an analog signal input from a pressure sensor into a digital signal. Output of a force-touch pressure may be checked by ADC. Points 1 to 4 are located inside from the edge of the display panel by 20 mm, and a point 5 is the center of the display panel. The ADC level was measured using weights having 150 g, 300 g, and 500 g and a diameter of 010. The results of the measurement are in Table 1 below, and are illustrated as a graph in FIG. 13B.

TABLE 1

| | ADC Level | | |
|---|---|---|---|
| Point | 150 g | 300 g | 450 g |
| \textcircled{1} | 80 | 250 | 410 |
| \textcircled{2} | 90 | 260 | 440 |
| \textcircled{3} | 60 | 210 | 400 |
| \textcircled{4} | 80 | 200 | 420 |
| \textcircled{5} | 120 | 270 | 450 |

It is found from Table 1that effective force-touch sensing is possible at all the points if the force-touch module is located in the display panel.

As described above, the present disclosure makes the reliable force-touch sensing possible even under the presence of the air gap inside the liquid crystal display panel. Further, the present disclosure provides the foam tape between the open cell inside the display panel and the bottom chassis to allow smooth force-touch sensing.

However, the effects that can be achieved by the display panel with an integrated force-touch sensor and the display device including the same according to the embodiments of the present disclosure are not limited to the foregoing, and other unmentioned effects can be clearly understood from the following description by those skilled in the technical field to which the present disclosure falls.

While exemplary embodiments of the present disclosure have been described, it will be apparent to those skilled in the art that various modifications and variations can be made therein without departing from the spirit and scope of the present disclosure. Thus, the scope of the present disclosure is not limited to the above embodiments, and should be defined by the appended claims and their equivalents.

What is claimed is:

1. A display panel comprising:
a display module having a liquid crystal layer;
a backlight module having a light source, a light guide plate that guides light emitted from the light source to the display module, and a bottom chassis that houses the light source and the light guide plate; and
a force-touch module located between the display module and the bottom chassis.

2. The display panel of claim 1, wherein the bottom chassis includes a bottom, a sidewall bent to extend from the bottom, and a bent top bent to extend from the sidewall.

3. The display panel of claim 2, wherein the bottom of the bottom chassis has a quadrilateral shape, and the bent top is formed to extend from the sidewall bent from the bottom.

4. The display panel of claim 2, wherein the bent top of the bottom chassis faces the display module.

5. The display panel of claim 2, wherein the display module includes a second polarization layer and the force-touch module is provided between the second polarization layer of the display module and the bent top of the bottom chassis.

6. The display panel of claim 5, wherein the force-touch module is continuously or intermittently formed along the bent top.

7. The display panel of claim 1, wherein the display module includes a first substrate, a second substrate, a liquid crystal layer disposed between the first substrate and the second substrate, and a color filter and an edge black matrix region disposed between the first substrate and the liquid crystal layer.

8. The display panel of claim 1, wherein the force-touch module is provided at a position corresponding to the edge black matrix region.

9. The display panel of claim 1, wherein the force-touch module includes a third substrate, a fourth substrate, an elastic resistor member disposed on a surface opposite to the fourth substrate below the third substrate, an electrode structure disposed on a surface opposite to the third substrate above the fourth substrate, and a spacer that separates the third substrate and the fourth substrate from each other.

10. The display panel of claim 9, wherein the force-touch module and the bottom chassis are connected via a first coupling member, one surface of the first coupling member is in contact with the fourth substrate of the force-touch module, and the other surface of the first coupling member is in contact with the bent top of the bottom chassis.

11. The display panel of claim 10, wherein a width of the first coupling member is smaller than or equal to that of the force-touch module.

12. The display panel of claim 10, wherein a thickness of the first coupling member ranges from 0.5 mm to 3.0 mm.

13. The display panel of claim 10, wherein the force-touch module and the display module are connected via a second coupling member, one surface of the second coupling member is in contact with the third substrate of the force-touch module, and the other surface of the second coupling member is in contact with the second polarization layer of the display module.

14. The display panel of claim 13, wherein each of the first coupling member and the second coupling member is a double-sided tape, a thermosetting adhesive, a photocurable adhesive, or a foam tape.

15. The display panel of claim 9, wherein a thickness of the spacer is less than a value obtained by adding a thickness of the elastic resistor member and a thickness of the electrode structure.

16. The display panel of claim 15, wherein the spacer further includes an adhesive layer.

17. The display panel of claim 15, wherein a thickness of the elastic resistor member ranges from 6 μm to 10 μm, a thickness of the electrode structure ranges from 4 μm to 5 μm, and a thickness of the spacer ranges from 5 μm to 10 μm.

18. The display panel of claim 15, wherein an air gap between the elastic resistor member and the electrode structure is smaller than or equal to 10 μm.

19. The display panel of claim 9, wherein a thickness of the spacer is greater than a value obtained by adding a thickness of the elastic resistor member and a thickness of the electrode structure.

20. A display device comprising:
a cover glass configured to protect a front surface of the display device;
a touch panel configured to have a touch sensor that detects a touch of a user;
a display panel configured to include a display module having a liquid crystal layer,
a backlight module having a light source, a light guide plate that guides light emitted from the light source to the display module, and a bottom chassis that houses the light source and the light guide plate, and a force-touch module located between the display module and the bottom chassis; and
a frame located below the display panel.
